(19) United States
(12) Patent Application Publication
(10) Pub. No.: US 2011/0190126 A1
(43) Pub. Date: Aug. 4, 2011

(54) WEED CONTROL METHOD AND HERBICIDAL COMPOSITION

(75) Inventors: Gavin John Hall, Berkshire (GB); Albrecht Michel, Basel (CH)

(73) Assignee: SYNGENTA CROP PROTECTION, INC., Greensboro, NC (US)

(21) Appl. No.: 12/997,021

(22) PCT Filed: Jun. 5, 2009
(86) PCT No.: PCT/EP2009/004035

§ 371 Date: Mar. 7, 2011

(30) Foreign Application Priority Data
Jun. 9, 2008 (GB) 0810554.6
Nov. 11, 2008 (GB) 0820634.4

(51) Int. Cl. A01N 43/40; A01N 43/66; A01N 43/707; A01N 43/68; A01N 25/32; A01N 43/824; A01N 43/653; A01P 13/00

(52) U.S. Cl. 504/103; 504/130; 504/134

(57) ABSTRACT

The present invention provides a method of selectively controlling unwanted vegetation at a locus comprising sugarcane and the unwanted vegetation, wherein the method comprises applying to the locus:—a. a herbicide of formula (I) or an agrochemically acceptable salt thereof; and b. a PS-II inhibiting herbicide; wherein the amount of component (a) and component (b) applied to the locus provides control of the unwanted vegetation and wherein the amount of component (b) applied safens the herbicidal effect of component (a) on the sugarcane. The invention further provides a herbicide composition comprising (a) a herbicide of formula (I) or an agrochemically acceptable salt thereof; and (b) a herbicide selected from the group consisting of metribuzin, hexazinone and tebuthiuron.

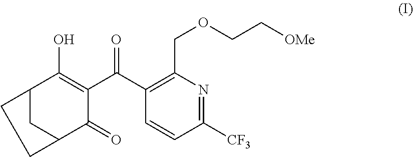

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use.

In some cases, active herbicides have been shown to be more effective in combination than when applied individually. The result is often termed “synergism”, since the combination demonstrates a potency or activity level exceeding that which it would be expected to have, based on knowledge of the individual potencies of the compounds. Thus the present invention resides in the discovery that the combination of a compound of formula (I)

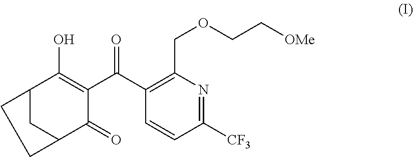

and photosystem-II (PS-II) inhibiting herbicides, already known individually for their herbicidal potency, display advantageous unexpected effects when applied in combination to control weeds in sugarcane. Combinations of a compound of formula I with PS-II inhibiting herbicides have already been reported—for example in EP1388285. However their use to control weeds in sugarcane has not hitherto been specifically reported—and it has now been discovered that, when used in sugarcane, such combinations offer sustained control of problematic grass weeds, unexpectedly improved control of problematic broad-leaf weeds whilst providing an unexpected overall reduction in sugarcane injury as compared to that which would be expected in respect of individual treatments.

Thus, according to the present invention there is provided a method of selectively controlling unwanted vegetation at a locus comprising sugarcane and the unwanted vegetation, wherein the method comprises applying to the locus:—
a. a herbicide of formula (I)

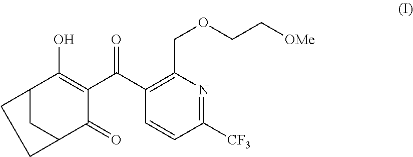

or an agrochemically acceptable salt thereof; and
b. a PS-II inhibiting herbicide;
wherein the amount of component (a) and component (b) applied to the locus provides control of the unwanted vegetation and wherein the amount of component (b) applied safens the herbicidal effect of component (a) on the sugarcane.

In a preferred embodiment of the present invention the amount of component (a) and component (b) applied to the locus also provides synergistic control of the unwanted vegetation.

In a preferred embodiment of the present invention the PS-II inhibiting herbicide is selected from the group consisting of a 1,3,5 triazine, a 1,2,4 triazinone, a triazolinone, and a urea.

In a particularly preferred embodiment the PS-II inhibiting herbicide is a 1,3,5 triazine selected from the group consisting of ametryn, atrazine, cyanazine, dimethametryn, prometon, prometryn, propazine, simazine, simetryn, terbumeton, terbuthylazine, terbutryn and trietazine, especially ametryn and/or atrazine and most preferably ametryn.

In an alternative embodiment the PS-II inhibiting herbicide is a 1,2,4 triazinone selected from the group consisting of hexazinone and metribuzin.

In another embodiment the PS-II inhibiting herbicide is the triazolinone amicarbazone.

In another embodiment the PS-II inhibiting herbicide is a urea selected from the group consisting of chlorotoluron, dimefuron, diuron, flumeturon, isoproturon, isouron, karbutilate, linuron, methabenzthiazuron, metoxuron, monolinuron, neburon, siduron and tebuthiuron. Tebuthiuron is particularly preferred.

The rate of application of the herbicide components may vary within wide limits and depends on the nature of the soil, the method of application (pre- or post-emergence, etc.), the crop plant, the undesired vegetation to be controlled, the prevailing climatic conditions, and other factors governed by the method of application, the time of application and the target crop. Typically the compound of formula (I) is applied at a rate from 50 to 500 g ai/ha, preferably from 100 to 300 g ai/ha, and more preferably from 150 to 300 g ai/ha. Typically the PS-II inhibiting herbicide is applied at a rate from 50 to 3000 g ai/ha, preferably from 150 to 2000 g ai/ha.

Components (a) and (b) may be applied simultaneously or in succession to the locus. The order of the compounds, in the event the application of the compounds is in succession, is not critical and the second compound is normally applied within preferably 2, more preferably 1, especially 0.5, days of the first compound. It is preferred, however, that components (a) and (b) are applied to the locus simultaneously in a combined herbicide composition. It should be understood that components (a) and (b) may be applied to the locus either pre-emergence and/or post-emergence. Preferably the components are both applied post emergence of the unwanted vegetation.

Unwanted vegetation is to be understood as those plants that affect the growth and quality of the sugarcane and examples include grasses, sedges and broad-leaved weeds. The term “locus” is to be understood to mean, for example, areas of cultivation such as areas of land on which the crop plants are already growing or in which the seed material of those crop plants has been sown. With regard to sugarcane—examples of unwanted vegetation typically include Ipomoea spp. (e.g Ipomoea grandifolia, Ipomoea acuminate, Ipomoea nil, Ipomea hederacea), Echinochloa spp., Digitaria spp. (e.g Digitaria horizontalis), Setaria spp., Sorghum spp., Brachiaria spp. (e.g Brachiaria decumbens and Brachiaria plantaginea), Kochia spp., Sida spp. (e.g Sida rhombifolia), Portulaca spp. (e.g Portulaca oleracea), Panicum spp. (e.g Panicum maximum), Cenchrus spp. (e.g Cenchrus echinatus), Cyperus spp, Eleusine spp. (e.g Eleusine indica), Chenopodium spp., Euphorbia spp. (e.g Euphorbia heterophylla) and Amarathus spp. (e.g Amaranthus viridis. Amaranthus retroflexus, Amaranthus hybridus). The method of the present invention is shown to provide good control of grass weeds—at least as good as would be expected with regard to the use of the individual active ingredients alone, but shown better than expected control of broad-leaf weeds, in particular Sida spp. and Portulaca spp. Furthermore, components (a) and (b) contained in the composition of the present invention are shown to result in less phytotoxicity to the sugarcane when applied in combination rather than when applied individually. This safening is unexpected.

The control of the unwanted vegetation ensures satisfactory crop yield and quality, and the grower of the crop has often to balance the costs associated with the use of compounds with the resulting yield, but generally an increase of, for example, at least 5% yield of a crop which has undergone compound treatment compared with an untreated crop is considered control by the compound.

It should also be appreciated that the one or more additional pesticides e.g herbicides, herbicide safeners, plant growth regulators, fertilizers, insecticides and/or fungicides, may be applied to the locus in the method of the present invention. It should be understood that the one or more additional pesticides may also be applied to sugarcane propagation material. In an especially preferred embodiment a herbicide safener applied in addition to the locus and/or sugarcane propagation material. Preferably, the herbicide safener is selected from the group consisting of a compound of formula 3.1

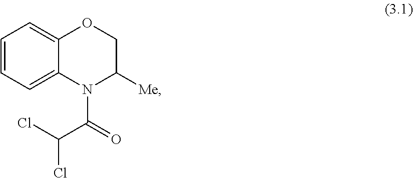

a compound of formula 3.2

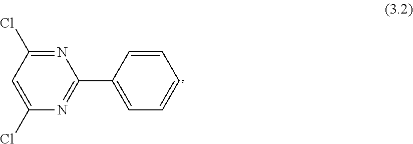

A compound of formula 3.3

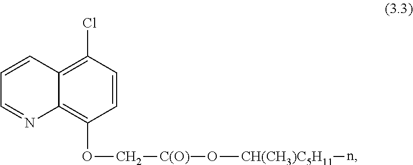

a compound of formula 3.4

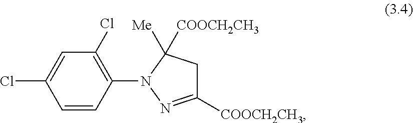

a compound of formula 3.5

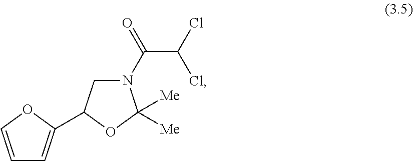

a compound of formula 3.6

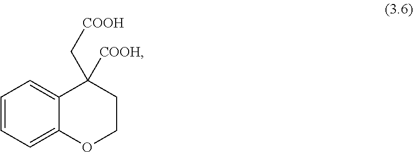

a compound of formula 3.7

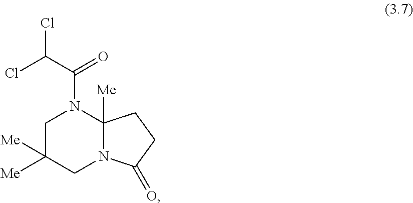

a compound of formula 3.8

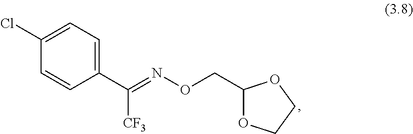

a compound of formula 3.9

Cl₂CHCON(CH₂CH═CH₂)₂ (3.9),

a compound of formula 3.10

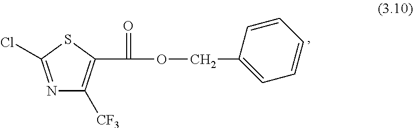

a compound of formula 3.11

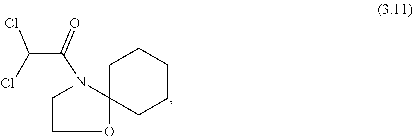

and of formula 3.12

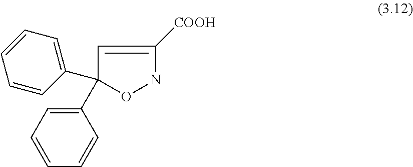

and the methyl and ethyl esters and salts thereof,
a compound of formula 3.13

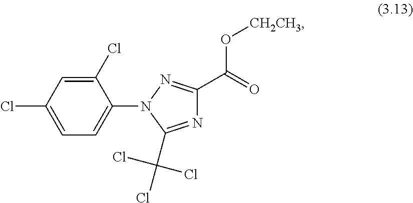

a compound of formula 3.14

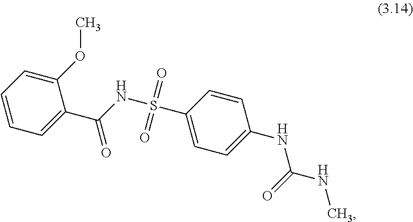

a compound of formula 3.15

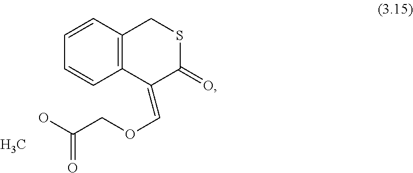

a compound of formula 3.16

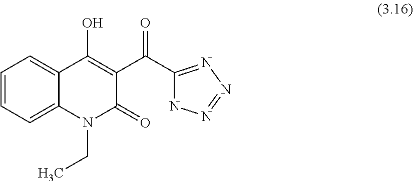

a compound of formula 3.17

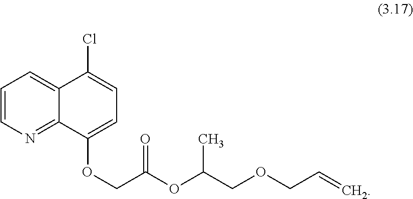

and a compound of formula 3.18

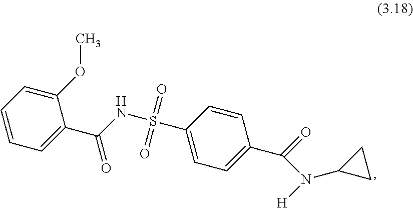

In the context of the present invention it should be understood that the sugarcane may also be rendered tolerant towards herbicides or classes or herbicides (such as, for example, HPPD (4-hydroxyphenyl-pyruvate-dioxygenase) inhibitors e.g mesotrione as described in, for example, WO02/46387, ACCase (Acetyl coenzyme A carboxylase) inhibitors, ALS (acetolactate synthase) inhibitors, EPSPS (5-enol-pyruvyl-shikimate-3-phosphate-synthase) inhibitors (e.g glyphosate), glutamine synthetase inhibitors (e.g glufosinate) by conventional breeding methods and/or via genetic engineering. In a preferred embodiment of the present invention the sugarcane is engineered to be resistant to glyphosate and the method further comprises applying to the locus glyphosate or an agrochemically acceptable salt thereof. The sugarcane may also be genetically engineered to be resistant to insects and/or fungi using methods well known in the art. The sugarcane may also have been engineered to have improved sugar and/or fibre content.

The present invention further provides a herbicide composition comprising:
a. a herbicide of formula (I)

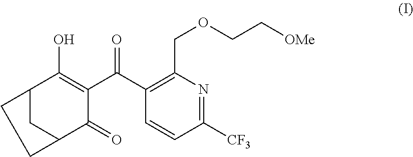

or an agrochemically acceptable salt thereof; and
b. a herbicide selected from the group consisting of metribuzin, hexazinone and tebuthiuron.

The herbicide composition of the present invention has been shown to provide a safening effect with regard to sugarcane and/or a synergistic herbicidal effect with regard to the unwanted vegetation.

In a preferred embodiment the herbicide composition comprises a herbicide of formula (I) and hexazinone.

The amount and ratio of components a (a) and (b) in the herbicide composition can vary depending on whether the composition is, for example, a pre-mix concentrate or a tank mixture. Preferably the weight ratio of compound (a) to compound (b) is in the range of from 1:0.5 to 1:100, more preferably from 1:0.5 to 1:10 (w/w).

It should also be appreciated that the herbicide composition of the present invention may comprise one or more additional pesticides e.g herbicides, herbicide safeners, fertilizers, plant growth regulators, insecticides and/or fungicides. In an especially preferred embodiment the herbicide composition further comprises a safener—preferably selected from the group consisting of a compound of formula 3.1 to 3.18 as herein described.

Examples of additional herbicides which may be comprised in the composition include glyphosate and/or glufosinate.

The herbicidal composition of the present invention will typically further comprise composition adjuvants conventionally used in formulation technology (also known as formulation auxiliaries), such as solvents, solid carriers or surfactants, for example, into emulsifiable concentrates, directly sprayable or dilutable solutions, wettable powders, soluble powders, dusts, granules or microcapsules, as described in WO 97/34483, pages 9 to 13. As with the nature of the formulation, the methods of application, such as spraying, atomising, dusting, wetting, scattering or pouring, are chosen in accordance with the intended objectives and the prevailing circumstances. The formulations can be prepared in a known manner, e.g., by intimately mixing and/or grinding the active ingredients with the formulation adjuvants, e.g., solvents or solid carriers. In addition, surface-active compounds (surfactants) may also be used in the preparation of the formulations.

Examples of solvents and solid carriers are given, for example, in WO 97/34485, page 6. Depending on the nature of the active ingredients to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, in WO 97/34485, pages 7 and 8. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopaedia of Surfactants”, Vol Chemical Publishing Co., New York, 1980-81.

The herbicidal formulations usually contain from 0.1 to 99% by weight, especially from 0.1 to 95% by weight, of active ingredient, from 0 to 25% by weight, especially from 0.1 to 25% by weight, of a surfactant, and the balance a solid or liquid formulation adjuvant.

Whereas commercial products are usually formulated as concentrates (also known as pre-mix), the end user will normally employ dilute formulations. The compositions may also comprise further ingredients, such as stabilisers, e.g., vegetable oils or epoxidised vegetable oils (epoxidised coconut oil, rapeseed oil or soybean oil), antifoams, e.g., silicone oil, preservatives, viscosity regulators, binders, tackifiers and also fertilisers or other active ingredients.

Preferred formulations have especially the following compositions:

(%=percent by weight)

### Emulsifiable Concentrates:

active ingredient mixture: 1 to 90%, preferably 5 to 20%
surfactant: 1 to 30%, preferably 10 to 20%
liquid carrier: balance

### Dusts:

active ingredient mixture: 0.1 to 10%, preferably 0.1 to 5%
solid carrier: 99.9 to 90%, preferably 99.9 to 95%

### Suspension Concentrates:

active ingredient mixture: 5 to 75%, preferably 10 to 50%
water: 94 to 24%, preferably 88 to 30%
surfactant: balance

### Wettable Powders:

active ingredient mixture: 0.5 to 90%, preferably 1 to 80%
surfactant: 0.5 to 20%, preferably 1 to 15%
solid carrier: balance

### Granules:

active ingredient mixture: 0.1 to 30%, preferably 0.5 to 15%
solid carrier: 99.9 to 70%, preferably 99.5 to 85%

Examples are specific formulations include:

F1. Emulsifiable concentrates

| | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

F2. Solutions

| | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

F3. Wettable powders

| | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

F4. Coated granules

| | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g., CaCO₃ or SiO₂ | | | |

The active ingredient is dissolved in methylene chloride and applied to the carrier by spraying, and the solvent is then evaporated off in vacuo.

F5. Coated granules

| | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g., CaCO₃ or SiO₂ | | | |

The finely ground active ingredient is uniformly applied, in a mixer, to the carrier moistened with polyethylene glycol. Non-dusty coated granules are obtained in this manner.

F6. Extruder granules

| | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

F7. Dusts

| | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

F8. Suspension concentrates

| | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the active ingredients of the combinations according to the invention to be formulated separately and to be brought together in the desired mixing ratio in the applicator in the form of a “tank mixture” in water shortly before application. Alternatively, a pre-mix composition containing compounds (a) and (b) are formulated together.

### EXAMPLES

### Example 1

Five field trials are carried out in 1.5 year plant cane to examine the effect on sugarcane of combinations of compound of Formula I with various PS-II inhibiting herbicides. Plot sizes are 20 m² and results shown are the average of 3 replicate treatments. The test results (summarised in Table 1) indicate that the phytotoxicity observed in sugarcane by the compound of Formula I can be surprisingly reduced when the compound is applied in conjunction with a PS-II inhibiting herbicide—an effect not observed when the compound of Formula I is applied in conjunction with a non-PSII inhibiting herbicide (sulfentrazone).

TABLE 1

| | Application | % Damage (Average |
|---|---|---|
| Herbicide Treatment | Rate (g/ha) | of three trials). |
| Herbicide of Formula I | 200 | 8 |
| Formula I + Ametryn | 200 + 1500 | 3.7 |
| Formula I + Atrazine | 200 + 2000 | 5.2 |
| Formula I + Metribuzin | 200 + 960 | 5 |
| Formula I + Hexazinone | 200 + 198 | 4.3 |
| Formula I + Tebuthiuron | 200 + 750 | 4.3 |
| Formula I + Sulfentrazone (non- | 200 + 600 | 13 |
| PS-II) | | |

### Example 2

A glasshouse study is performed to examine the effect of combination of compound of Formula I with various PS-II inhibiting herbicides on various weed species.

Test species are Brachiaria decumbens (BRADC); Digitaria horizontalis (DIGHO); Ipomea hederacea (IPOHE) and Euphorbia heterophylla (EUPHE) which are sprayed post-emergence at 3, 4, 1.5 and 2.5 leaves respectively.

The compound of Formula I is provided as a 200 g/l SC. Hexazinone is provided as a 240 g/l SL, Tebuthiuron as a 80 WG and Amicarbazone as a 70 WG. All treatments are applied with 0.5% Agridex at 200 l/ha. Plants were visually assessed for % weed control at 10 & 20 days after application (DAA)

The data obtained are analysed by comparing the observed mean response for the mixture treatments with their expected response using the Colby formula shown below:

P_{M}=P₁+P₂−P₁·P₂/100

where P_{M} denotes the expected response of the mixture treatment and P₁ and P₂ denote the observed mean responses from each of the mixture components tested alone.

The test results (shown in Tables 2 and 3) indicate synergy exists when a compound of Formula I is applied in conjunction with a PS-II inhibiting herbicide.

TABLE 2
% Weed Control 10 DAA

| | | | | BRADC | | | DIGHO | | | EUPHE | | | IPOHE | | |
|---|---|---|---|---|---|---|---|---|---|---|---|---|---|---|---|
| Trt | Herbicide | Rate | Mixture Partner | Obs. | Exp. | Diff | Obs. | Exp. | Diff | Obs. | Exp. | Diff | Obs. | Exp. | Diff |
| 1 | Formula I | 3 | | 6.7 | | | 6.7 | | | 21.7 | | | 30.0 | | |
| 2 | | 6 | | 10.0 | | | 6.7 | | | 25.0 | | | 35.0 | | |
| 3 | | 12 | | 23.3 | | | 18.3 | | | 30.0 | | | 40.0 | | |
| 4 | | 25 | | 30.0 | | | 28.3 | | | 36.7 | | | 41.7 | | |
| 5 | Hexazinone | 12 | | 3.3 | | | 1.7 | | | 11.7 | | | 11.7 | | |
| 6 | | 25 | | 20.0 | | | 26.7 | | | 26.7 | | | 23.3 | | |
| 7 | | 50 | | 40.0 | | | 45.0 | | | 48.3 | | | 35.0 | | |
| 8 | Tebuthiuron | 50 | | 13.3 | | | 1.7 | | | 28.3 | | | 15.0 | | |
| 9 | | 100 | | 23.3 | | | 10.0 | | | 58.3 | | | 20.0 | | |
| 10 | | 200 | | 40.0 | | | 35.0 | | | 66.7 | | | 31.7 | | |
| 11 | Amicarbazone | 30 | | 1.7 | | | 5.0 | | | 25.0 | | | 30.0 | | |
| 12 | | 60 | | 10.0 | | | 5.0 | | | 38.3 | | | 41.7 | | |
| 13 | | 120 | | 31.7 | | | 23.3 | | | 45.0 | | | 60.0 | | |
| 14 | Formula I | 3 | Hexazinone | 25.0 | 9.8 | 15.2 | 15.0 | 8.2 | 6.8 | 41.7 | 30.8 | 10.9 | 43.3 | 38.2 | 5.2 |
| 15 | | 6 | 12 g/ha | 50.0 | 13.0 | 37.0 | 28.3 | 8.2 | 20.1 | 56.7 | 33.8 | 22.9 | 63.3 | 42.6 | 20.8 |
| 16 | | 12 | | 53.3 | 25.9 | 27.4 | 33.3 | 19.7 | 13.6 | 68.3 | 38.2 | 30.2 | 78.3 | 47.0 | 31.3 |
| 17 | | 25 | | 58.3 | 32.3 | 26.0 | 36.7 | 29.5 | 7.1 | 75.0 | 44.1 | 30.9 | 71.7 | 48.5 | 23.2 |
| 18 | Formula I | 3 | Hexazinone | 41.7 | 25.3 | 16.3 | 38.3 | 31.6 | 6.8 | 78.3 | 42.6 | 35.8 | 75.0 | 46.3 | 28.7 |
| 19 | | 6 | 25 g/ha | 55.0 | 28.0 | 27.0 | 46.7 | 31.6 | 15.1 | 81.7 | 45.0 | 36.7 | 85.0 | 50.2 | 34.8 |
| 20 | | 12 | | 60.0 | 38.7 | 21.3 | 53.3 | 40.1 | 13.2 | 85.0 | 48.7 | 36.3 | 90.0 | 54.0 | 36.0 |
| 21 | | 25 | | 71.7 | 44.0 | 27.7 | 70.0 | 47.4 | 22.6 | 88.3 | 53.6 | 34.8 | 91.0 | 55.3 | 35.7 |
| 22 | Formula I | 3 | Hexazinone | 66.7 | 44.0 | 22.7 | 56.7 | 48.7 | 8.0 | 72.3 | 59.5 | 12.8 | 81.7 | 54.5 | 27.2 |
| 23 | | 6 | 50 g/ha | 70.0 | 46.0 | 24.0 | 63.3 | 48.7 | 14.7 | 76.7 | 61.3 | 15.4 | 83.3 | 57.8 | 25.6 |
| 24 | | 12 | | 75.0 | 54.0 | 21.0 | 76.7 | 55.1 | 21.6 | 88.3 | 63.8 | 24.5 | 90.0 | 61.0 | 29.0 |
| 25 | | 25 | | 80.0 | 58.0 | 22.0 | 81.7 | 60.6 | 21.1 | 85.0 | 67.3 | 17.7 | 88.3 | 62.1 | 26.3 |
| 26 | Formula I | 3 | Tebuthiuron | 28.3 | 19.1 | 9.2 | 11.7 | 8.2 | 3.4 | 40.0 | 43.9 | −3.9 | 43.3 | 40.5 | 2.8 |
| 27 | | 6 | 50 g/ha | 50.0 | 22.0 | 28.0 | 25.0 | 8.2 | 16.8 | 80.0 | 46.3 | 33.8 | 71.7 | 44.8 | 26.9 |
| 28 | | 12 | | 58.3 | 33.6 | 24.8 | 33.3 | 19.7 | 13.6 | 85.0 | 49.8 | 35.2 | 80.0 | 49.0 | 31.0 |
| 29 | | 25 | | 65.0 | 39.3 | 25.7 | 35.0 | 29.5 | 5.5 | 86.7 | 54.6 | 32.1 | 85.0 | 50.4 | 34.6 |
| 30 | Formula I | 3 | Tebuthiuron | 53.3 | 28.4 | 24.9 | 21.7 | 16.0 | 5.7 | 77.7 | 67.4 | 10.3 | 71.7 | 44.0 | 27.7 |
| 31 | | 6 | 100 g/ha | 55.0 | 31.0 | 24.0 | 26.7 | 16.0 | 10.7 | 80.0 | 68.8 | 11.3 | 76.7 | 48.0 | 28.7 |
| 32 | | 12 | | 60.0 | 41.2 | 18.8 | 40.0 | 26.5 | 13.5 | 85.0 | 70.8 | 14.2 | 80.7 | 52.0 | 28.7 |
| 33 | | 25 | | 70.0 | 46.3 | 23.7 | 46.7 | 35.5 | 11.2 | 86.7 | 73.6 | 13.1 | 88.3 | 53.3 | 35.0 |
| 34 | Formula I | 3 | Tebuthiuron | 61.7 | 44.0 | 17.7 | 43.3 | 39.3 | 4.0 | 85.0 | 73.9 | 11.1 | 71.7 | 52.2 | 19.5 |
| 35 | | 6 | 200 g/ha | 70.0 | 46.0 | 24.0 | 46.7 | 39.3 | 7.3 | 88.3 | 75.0 | 13.3 | 86.7 | 55.6 | 31.1 |
| 36 | | 12 | | 78.3 | 54.0 | 24.3 | 50.0 | 46.9 | 3.1 | 88.3 | 76.7 | 11.7 | 91.7 | 59.0 | 32.7 |
| 37 | | 25 | | 80.0 | 58.0 | 22.0 | 51.7 | 53.4 | −1.8 | 89.3 | 78.9 | 10.4 | 88.3 | 60.1 | 28.2 |
| 38 | Formula I | 3 | Amicarbazone | 0.0 | 8.2 | −8.2 | 0.0 | 11.3 | −11.3 | 30.0 | 41.3 | −11.3 | 38.3 | 51.0 | −12.7 |
| 39 | | 6 | 30 g/ha | 25.0 | 11.5 | 13.5 | 11.7 | 11.3 | 0.3 | 46.7 | 43.8 | 2.9 | 68.3 | 54.5 | 13.8 |
| 40 | | 12 | | 33.3 | 24.6 | 8.7 | 26.7 | 22.4 | 4.3 | 66.7 | 47.5 | 19.2 | 86.7 | 58.0 | 28.7 |
| 41 | | 25 | | 45.0 | 31.2 | 13.8 | 35.0 | 31.9 | 3.1 | 76.7 | 52.5 | 24.2 | 88.3 | 59.2 | 29.2 |
| 42 | Formula I | 3 | Amicarbazone | 26.7 | 16.0 | 10.7 | 20.0 | 11.3 | 8.7 | 65.0 | 51.7 | 13.3 | 68.3 | 59.2 | 9.2 |
| 43 | | 6 | 60 g/ha | 33.3 | 19.0 | 14.3 | 31.7 | 11.3 | 20.3 | 76.7 | 53.8 | 22.9 | 80.0 | 62.1 | 17.9 |
| 44 | | 12 | | 43.3 | 31.0 | 12.3 | 45.0 | 22.4 | 22.6 | 78.3 | 56.8 | 21.5 | 85.0 | 65.0 | 20.0 |
| 45 | | 25 | | 68.3 | 37.0 | 31.3 | 53.3 | 31.9 | 21.4 | 88.3 | 60.9 | 27.4 | 86.7 | 66.0 | 20.7 |
| 46 | Formula I | 3 | Amicarbazone | 68.3 | 36.2 | 32.1 | 60.0 | 28.4 | 31.6 | 85.0 | 56.9 | 28.1 | 85.0 | 72.0 | 13.0 |
| 47 | | 6 | 120 g/ha | 70.0 | 38.5 | 31.5 | 68.3 | 28.4 | 39.9 | 83.3 | 58.8 | 24.6 | 90.0 | 74.0 | 16.0 |
| 48 | | 12 | | 75.0 | 47.6 | 27.4 | 66.7 | 37.4 | 29.3 | 88.3 | 61.5 | 26.8 | 88.3 | 76.0 | 12.3 |
| 49 | | 25 | | 76.7 | 52.2 | 24.5 | 73.3 | 45.1 | 28.3 | 90.0 | 65.2 | 24.8 | 94.7 | 76.7 | 18.0 |

TABLE 3
% Weed Control 20 DAA

| | | | | BRADC | | | DIGHO | | | EUPHE | | | IPOHE | | |
|---|---|---|---|---|---|---|---|---|---|---|---|---|---|---|---|
| Trt | Herbicide | Rate | Mixture Partner | Obs. | Exp. | Diff | Obs. | Exp. | Diff | Obs. | Exp. | Diff | Obs. | Exp. | Diff |
| 1 | Formula I | 3 | | 0.0 | | | 0.0 | | | 1.7 | | | 38.3 | | |
| 2 | | 6 | | 0.0 | | | 0.0 | | | 3.3 | | | 43.3 | | |
| 3 | | 12 | | 10.0 | | | 6.7 | | | 18.3 | | | 48.3 | | |
| 4 | | 25 | | 23.3 | | | 13.3 | | | 35.0 | | | 56.7 | | |
| 5 | Hexazinone | 12 | | 0.0 | | | 3.3 | | | 3.3 | | | 13.3 | | |
| 6 | | 25 | | 15.0 | | | 6.7 | | | 8.3 | | | 23.3 | | |
| 7 | | 50 | | 36.7 | | | 16.7 | | | 16.7 | | | 41.7 | | |
| 8 | Tebuthiuron | 50 | | 0.0 | | | 0.0 | | | 8.3 | | | 10.0 | | |
| 9 | | 100 | | 8.3 | | | 8.3 | | | 26.7 | | | 18.3 | | |
| 10 | | 200 | | 28.3 | | | 31.7 | | | 35.0 | | | 26.7 | | |
| 11 | Amicarbazone | 30 | | 0.0 | | | 0.0 | | | 3.3 | | | 25.0 | | |
| 12 | | 60 | | 3.3 | | | 8.3 | | | 1.7 | | | 40.0 | | |
| 13 | | 120 | | 30.0 | | | 41.7 | | | 25.0 | | | 53.3 | | |
| 14 | Formula I | 3 | Hexazinone | 16.7 | 0.0 | 16.7 | 8.3 | 3.3 | 5.0 | 11.7 | 4.9 | 6.7 | 40.0 | 46.6 | −6.6 |
| 15 | | 6 | 12 g/ha | 38.3 | 0.0 | 38.3 | 10.0 | 3.3 | 6.7 | 18.3 | 6.6 | 11.8 | 83.3 | 50.9 | 32.4 |
| 16 | | 12 | | 46.7 | 10.0 | 36.7 | 30.0 | 9.8 | 20.2 | 35.0 | 21.1 | 13.9 | 83.3 | 55.2 | 28.1 |
| 17 | | 25 | | 55.0 | 23.3 | 31.7 | 45.0 | 16.2 | 28.8 | 61.7 | 37.2 | 24.5 | 86.7 | 62.4 | 24.2 |
| 18 | Formula I | 3 | Hexazinone | 28.3 | 15.0 | 13.3 | 18.3 | 6.7 | 11.7 | 30.0 | 9.9 | 20.1 | 61.7 | 52.7 | 8.9 |
| 19 | | 6 | 25 g/ha | 45.0 | 15.0 | 30.0 | 31.7 | 6.7 | 25.0 | 36.7 | 11.4 | 25.3 | 91.7 | 56.6 | 35.1 |
| 20 | | 12 | | 58.3 | 23.5 | 34.8 | 40.0 | 12.9 | 27.1 | 48.3 | 25.1 | 23.2 | 88.3 | 60.4 | 27.9 |
| 21 | | 25 | | 66.7 | 34.8 | 31.8 | 55.0 | 19.1 | 35.9 | 71.7 | 40.4 | 31.3 | 90.0 | 66.8 | 23.2 |
| 22 | Formula I | 3 | Hexazinone | 53.3 | 36.7 | 16.7 | 36.7 | 16.7 | 20.0 | 43.3 | 18.1 | 25.3 | 50.0 | 64.0 | −14.0 |
| 23 | | 6 | 50 g/ha | 60.0 | 36.7 | 23.3 | 53.3 | 16.7 | 36.7 | 50.0 | 19.4 | 30.6 | 83.3 | 66.9 | 16.4 |
| 24 | | 12 | | 65.0 | 43.0 | 22.0 | 65.0 | 22.2 | 42.8 | 70.0 | 31.9 | 38.1 | 88.3 | 69.9 | 18.5 |
| 25 | | 25 | | 73.3 | 51.4 | 21.9 | 86.7 | 27.8 | 58.9 | 88.3 | 45.8 | 42.5 | 91.7 | 74.7 | 16.9 |
| 26 | Formula I | 3 | Tebuthiuron | 31.7 | 0.0 | 31.7 | 16.7 | 0.0 | 16.7 | 18.3 | 9.9 | 8.5 | 28.3 | 44.5 | −16.2 |
| 27 | | 6 | 50 g/ha | 40.0 | 0.0 | 40.0 | 30.0 | 0.0 | 30.0 | 31.7 | 11.4 | 20.3 | 41.7 | 49.0 | −7.3 |
| 28 | | 12 | | 53.3 | 10.0 | 43.3 | 36.7 | 6.7 | 30.0 | 40.0 | 25.1 | 14.9 | 51.7 | 53.5 | −1.8 |
| 29 | | 25 | | 55.0 | 23.3 | 31.7 | 41.7 | 13.3 | 28.3 | 51.7 | 40.4 | 11.3 | 68.3 | 61.0 | 7.3 |
| 30 | Formula I | 3 | Tebuthiuron | 21.7 | 8.3 | 13.3 | 11.7 | 8.3 | 3.3 | 23.3 | 27.9 | −4.6 | 28.3 | 49.6 | −21.3 |
| 31 | | 6 | 100 g/ha | 38.3 | 8.3 | 30.0 | 23.3 | 8.3 | 15.0 | 28.3 | 29.1 | −0.8 | 35.0 | 53.7 | −18.7 |
| 32 | | 12 | | 51.7 | 17.5 | 34.2 | 41.7 | 14.4 | 27.2 | 43.3 | 40.1 | 3.2 | 38.3 | 57.8 | −19.5 |
| 33 | | 25 | | 68.3 | 29.7 | 38.6 | 46.7 | 20.6 | 26.1 | 56.7 | 52.3 | 4.3 | 63.3 | 64.6 | −1.3 |
| 34 | Formula I | 3 | Tebuthiuron | 25.0 | 28.3 | −3.3 | 41.7 | 31.7 | 10.0 | 43.3 | 36.1 | 7.3 | 48.3 | 54.8 | −6.4 |
| 35 | | 6 | 200 g/ha | 40.0 | 28.3 | 11.7 | 46.7 | 31.7 | 15.0 | 50.0 | 37.2 | 12.8 | 65.0 | 58.4 | 6.6 |
| 36 | | 12 | | 45.0 | 35.5 | 9.5 | 60.0 | 36.2 | 23.8 | 61.7 | 46.9 | 14.8 | 65.0 | 62.1 | 2.9 |
| 37 | | 25 | | 66.7 | 45.1 | 21.6 | 70.0 | 40.8 | 29.2 | 71.7 | 57.8 | 13.9 | 71.7 | 68.2 | 3.4 |
| 38 | Formula I | 3 | Amicarbazone | 0.0 | 0.0 | 0.0 | 0.0 | 0.0 | 0.0 | 6.7 | 4.9 | 1.7 | 16.7 | 53.8 | −37.1 |
| 39 | | 6 | 30 g/ha | 20.0 | 0.0 | 20.0 | 1.7 | 0.0 | 1.7 | 28.3 | 6.6 | 21.8 | 35.0 | 57.5 | −22.5 |
| 40 | | 12 | | 30.0 | 10.0 | 20.0 | 16.7 | 6.7 | 10.0 | 53.3 | 21.1 | 32.3 | 65.0 | 61.3 | 3.7 |
| 41 | | 25 | | 48.3 | 23.3 | 25.0 | 35.0 | 13.3 | 21.7 | 76.7 | 37.2 | 39.5 | 88.3 | 67.5 | 20.8 |
| 42 | Formula I | 3 | Amicarbazone | 20.0 | 3.3 | 16.7 | 10.0 | 8.3 | 1.7 | 36.7 | 3.3 | 33.4 | 38.3 | 63.0 | −24.7 |
| 43 | | 6 | 60 g/ha | 28.3 | 3.3 | 25.0 | 20.0 | 8.3 | 11.7 | 36.7 | 4.9 | 31.7 | 48.3 | 66.0 | −17.7 |
| 44 | | 12 | | 40.0 | 13.0 | 27.0 | 25.0 | 14.4 | 10.6 | 48.3 | 19.7 | 28.6 | 63.3 | 69.0 | −5.7 |
| 45 | | 25 | | 60.0 | 25.9 | 34.1 | 40.0 | 20.6 | 19.4 | 65.0 | 36.1 | 28.9 | 76.7 | 74.0 | 2.7 |
| 46 | Formula I | 3 | Amicarbazone | 55.0 | 30.0 | 25.0 | 41.7 | 41.7 | 0.0 | 31.7 | 26.3 | 5.4 | 66.7 | 71.2 | −4.6 |
| 47 | | 6 | 120 g/ha | 61.7 | 30.0 | 31.7 | 53.3 | 41.7 | 11.7 | 43.3 | 27.5 | 15.8 | 73.3 | 73.6 | −0.2 |
| 48 | | 12 | | 75.0 | 37.0 | 38.0 | 61.7 | 45.6 | 16.1 | 68.3 | 38.8 | 29.6 | 90.0 | 75.9 | 14.1 |
| 49 | | 25 | | 80.0 | 46.3 | 33.7 | 73.3 | 49.4 | 23.9 | 76.7 | 51.3 | 25.4 | 90.0 | 79.8 | 10.2 |

1. A method of selectively controlling unwanted vegetation at a locus comprising sugarcane and the unwanted vegetation, wherein the method comprises applying to the locus:—
a. a herbicide of formula (I) 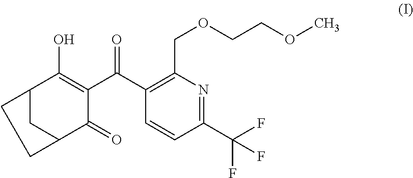
or an agrochemically acceptable salt thereof; and
b. a PS-II inhibiting herbicide;
wherein the amount of component (a) and component (b) applied to the locus provides control of the unwanted vegetation and wherein the amount of component (b) applied safens the herbicidal effect of component (a) on the sugarcane.

2. A method according to claim 1, wherein the PS-II inhibiting herbicide is selected from the group consisting of a 1,3,5 triazine, a 1,2,4 triazinone and a urea.

3. A method according to claim 2, wherein the PS-II inhibiting herbicide is a 1,3,5 triazine selected from the group consisting of ametryn, atrazine, cyanazine, dimethametryn, prometon, prometryn, propazine, simazine, simetryn, terbumeton, terbuthylazine, terbutryn and trietazine.

4. A method according to claim 3, wherein the PS-II inhibiting herbicide is selected from the group consisting of ametryn and atrazine.

5. A method according to claim 2, wherein the PS-II inhibiting herbicide is a 1,2,4 triazinone selected from the group consisting of hexazinone and metribuzin.

6. A method according to claim 2, wherein the PS-II inhibiting herbicide is amicarbazone.

7. A method according to claim 2, wherein the PS-II inhibiting herbicide is a urea selected from the group consisting of chlorotoluron, dimefuron, diuron, flumeturon, isoproturon, isouron, karbutilate, linuron, methabenzthiazuron, metoxuron, monolinuron, neburon, siduron and tebuthiuron.

8. A method according to claim 7, wherein the urea is tebuthiuron.

9. A method according to claim 1, wherein the compound of formula (I) is applied to the locus at a rate from 50 to 500 g ai/ha and the PS-II inhibiting herbicide is applied to the locus at a rate from 50 to 3000 g ai/ha.

10. A method according to claim 1, wherein components (a) and (b) are applied to the locus simultaneously.

11. A method according to claim 1, wherein components (a) and (b) are applied post-emergence.

12. A herbicide composition comprising:
a. a herbicide of formula (I) 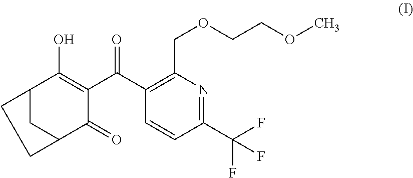
or an agrochemically acceptable salt thereof; and
b. a herbicide selected from the group consisting of metribuzin, hexazinone and tebuthiuron.

13. A herbicide composition according to claim 12, comprising a herbicide of formula (I) and hexazinone.

14. A herbicide composition according to claim 12, further comprising an additional herbicide and/or herbicide safener.

15. (canceled)

16. (canceled)
